(19) United States
(12) Patent Application Publication
(10) Pub. No.: US 2009/0179856 A1
(43) Pub. Date: Jul. 16, 2009

(54) Special Mouse

(76) Inventor: Lorraine Morgan Scott, San Clemente, CA (US)

Correspondence Address: Lorraine Morgan Scott, 8011 Langbrook Rd, Springfield, VA, 22152, US

(21) Appl. No.: 11/972,626

(22) Filed: Jan. 11, 2008

(51) Int. Cl. G09G 5/00; G06F 3/033

(52) U.S. Cl. 345/157; 345/156

(57) ABSTRACT

An optical wireless, cordless computer input device also known as a computer mouse, shaped as a vehicle, with remote control vehicle capability comprising: (a) a sheet of rigid material having sufficient size to fit in the cupped palm of an average size adult hand, (b) a plurality of same-sized moveable support wheels and tires, (c) said support wheels are underneath the rigid material frame, (d) comprising a retractable light emitting diode (LED) and sensor underneath the rigid material frame, (e) comprising separate power sources for the computer input device (mouse) and remote control vehicle underneath the rigid material frame. Both the optical mouse and vehicle are operated on a diverse number of surfaces, and operated independently from independent power sources.

### CROSS REFERENCE TO RELATED APPLICATIONS

Not Applicable

### STATEMENT REGARDING FEDERAL SPONSORED RESEARCH AND DEVELOPMENT

None and Not Applicable

### REFERENCE TO SEQUENCE LISTING, TABLE, PROGRAM, COMPAC DISK, OR APPENDIX

None and Not Applicable

### BACKGROUND OF INVENTION

The present invention relates directly to both a computer input device (mouse) and a remote control toy vehicle.

It has been found that using a computer for lengthy periods of time may cause back, neck, shoulder, and wrist soreness, as well as eye strain. It has also been found that a wireless, cordless optical mouse with a light emitting diode (LED) sensor has a relatively high level of functionality. Furthermore, it has been found that remote control toy vehicles generally have relatively high levels of play value, and vehicles which are capable of moving forward, turning, moving in reverse, and generally having the capability to move at great speed have increased levels of play value.

As a result, a number of remote control toy vehicles have been heretofore available which have been adapted to speed, turn, move forward, and perform various stunts. Also, as a result, a number of wireless, cordless, optical mouse with either a trackball or LED sensor have been heretofore available. In general, however, the heretofore available remote control vehicles and the heretofore wireless, cordless, optical mouse have not been adapted to perform their said functions as one unit housed in the shape of the vehicle.

Furthermore, it has been found an object that can audibly engage the listener to cause a smile, snicker, or laugh is a stress-reliever.

The present invention provides a new and innovative toy vehicle and computer input device (also referred to as a mouse) which is capable of performing maneuvers as a toy remote controlled vehicle as well as performing computer cursor movement and scrolling as a LED optical wireless, cordless mouse.

Still more specifically, the toy vehicle of the present invention comprises a chassis, a plurality of wheels mounted on the chassis for movably supporting the chassis on a supporting surface, and a drive assembly on the chassis for driving at least one of the support wheels in order to propel the vehicle on the supporting surface. The toy vehicle preferably comprises four support wheels and at least one drive motor for driving two of the four support wheels. The support wheels are preferably all of substantially the same diameter, and the drive assembly preferably includes a battery power supply, and the drive motor or motors and the battery power supply are preferably positioned between the front and rear axles with the weights thereof substantially uniformly distributed on opposite sides of the central plane of the vehicle chassis.

The remote control toy vehicle preferably further comprises a remote control receiver and an antenna. The receiver is preferably mounted within the body portion of the chassis, and the antenna can be positioned, constructed, and dimensioned so that it is either contained entirely within the outer perimeter of the vehicle or positioned on the right upper, exterior portion of the vehicle in a manner such as an automobile antenna.

Also specific about the present invention is the optical computer input device. The present invention has been made keeping in mind the problems occurring in the prior art of the ball-type mouse, and also of the problem of prior art light-receiving optical, or Led mouse, and an object of the present invention is to provide a wireless, cordless optical computer input device housed in a remote control vehicle equipped, preferably, with lights and sound track. Still more specifically, the computer input device is operable from within the toy vehicle by unhinging and releasing (lowering) the light receiving unit, light source, and lens for converging light, which, when unhinged is a predetermined height, preferably 1-2 mm's. When the light-receiving unit is lowered heretofore, the computer input device is in the ready and operational position. Additionally, the computer input device rolls across the support surface on the toy vehicle wheels with the light receiving unit in the same manner and with the same results as prior art optical input devices.

Additionally, remote control toy vehicles are well known. One subset of these vehicles is configured to faithfully replicate known or otherwise conventional vehicles to allow users to pretend they are driving real vehicles. Another subset of such vehicles is more fanciful and designed for unusual performance capability, typically being capable of performing stunts. Some vehicles are provided with lights and sound to enhance the amusement value of such toys. Purchasers are attracted to and manufactures try to provide remotely controlled toy vehicles having new features and/or capabilities not previously provided in such vehicles.

Furthermore, computer work can be boring, monotonous, tedious, stressful, and just plain work. While manufactures and consumers are attracted to computer input devices (mice) that have new features and/or capabilities, to the best of my knowledge, no other computer input device, especially one with an optical LED device has been invented that also provide the fun and amusement of a remote control toy vehicle.

There is a need, therefore, for a wireless input device that employs optical sensing to effect the likes of cursor movement and scrolling which when housed inside a toy remote control vehicle which, may result in an energized, reduced-stress, fun atmosphere.

### Related Patents:

| | | |
|---|---|---|
| Arrigo et al | Aug. 24, 2004 | 6,781,570 B1 |
| Paik et al | Dec. 31, 2002 | 6,501,460 B1 |
| Chen | Oct. 10, 2006 | 7,119,793 B2 |
| Adan | Mar. 11, 2003 | 6,531,692 |
| Queveau et al | Oct. 9, 2007 | 7,278,676 |
| George et al | Mar. 17, 1998 | 5,727,985 |
| Sun et al | Jul. 4, 2006 | 7/071,922 |
| Theytaz et al | Nov. 7, 2006 | 7,131,751 |
| Trageser et al | Oct. 2, 2007 | 7,275,975 |
| Urquiaga | Aug. 10, 2004 | 6,773,321 |
| Weiss et al | Jun. 26, 2007 | 7,234,992 |
| Ogihara | Oct. 31, 2006 | 7,128,634 |
| Lynders | Aug. 9, 2003 | 6,926,581 |
| Watanabe | Sep. 17, 2002 | 6,450,857 |
| Anderson | Dec. 02, 2003 | 6,657,184 B2 |
| Leonov | Jun. 26, 2007 | 7,234,990 |
| Biheller | Jan. 24, 2006 | 6,989,818 |
| Boyle | Sep. 25, 2001 | 6,293,798 B1 |
| Cheng | Oct. 26, 2004 | 6,809,275 |
| Koo | Jan. 17, 2006 | 6,787,505 |
| Lo | Jun. 26, 2007 | 7,234,991 B2 |

### Non Patent Related Items

### Microsoft Wireless Optical Mouse 4000 P/N X803393-003

### Microsoft Wireless Optical Mouse 2000 P/N X806939-002

### Tyco RC Remote Control 49 MHz Car Body Shell 88269-2119

### BRIEF SUMMARY OF THE INVENTION

A remotely controlled toy vehicle including at least an on-board power supply, at least a plurality of wheels supporting the vehicle for itinerant movement, at least one motor operably coupled to at least one of the wheels to provide at least part of the itinerant movement of the vehicle, a controller circuit configured to selectively supply power from the power supply to at least one motor in response to commands from a transmitter remote from said vehicle to move the toy vehicle and at least one optical light emitting diode, a receiving source providing displacement information to a Computer Operating System, the pointing device comprising: a retractable frame for a light source to generate a light beam to illuminate an image area; an illumination lens for directing the light beam from the light source to the imaged area on a surface, the imaged area of the surface reflecting light, the received reflected light for use in providing the displacement information from the imaged area: to the computer, and an on-board power supply to power said computer input device independent from said remote control toy vehicle.

### BRIEF DESCRIPTION OF THE DRAWINGS

The foregoing summary, as well as the following detailed description of preferred embodiments of the invention, will be better understood when read in conjunction with the appended drawings, and objects other than those set forth above will become apparent when consideration is given to the following detailed description thereof. For the purpose of illustrating the invention, there is shown in the drawings an embodiment which is presently preferred. It should be understood, however, that the invention is not limited to the precise arrangements and instrumentalities shown. Such description makes reference to the annexed drawings wherein:

FIG. 1 shows the left side or lateral perspective of device 101, computer input device and toy remote control vehicle not in use;

FIG. 2 is a top perspective view of the present invention device 101;

FIG. 3 is the bottom perspective of the present invention base 50; of device 101, the gear train (not shown) is similar to U.S. Pat. No. 5,727,985, incorporated by reference herein, with a central driven gear directly by the motor pinion, a pair of spur gears driven by the central drive gear and a pair of wheel gears driven by the spur gears, each wheel gear including a splined drive shaft non-rotatably received in one of the wheels 7, 15.

FIG. 4 is an exploded perspective view of the present invention retractable LED unit 35;

FIG. 5 shows the exploded side perspective of retractable LED unit 35 in the up position (not in use);

FIG. 6 shows the exploded side perspective of retractable LED unit 35 in the down position (the LED unit is in use;)

FIG. 7 is a perspective view of the top side of base 50, of the vehicle circuit board 27, computer input device circuit board 28, antenna 29, drive motor 30, axles 31, 32, 33, 34, area for retractable LED unit 35, and the gears 22;

FIG. 8 is a perspective view of a first longitudinal end of device 101, incorporating the remote control toy vehicle and computer input device;

FIG. 9 is a perspective view of the transmitter or controller 58.

### DETAILED DESCRIPTION OF THE INVENTION

Certain terminology is used in the following description for convenience only and is not limiting. The words “left”, “right”, “top”, “bottom”, and “underneath” and the like designate directions in the drawings to which reference is made. The terminology includes the words above specifically mentioned, derivatives thereof and words of similar meaning.

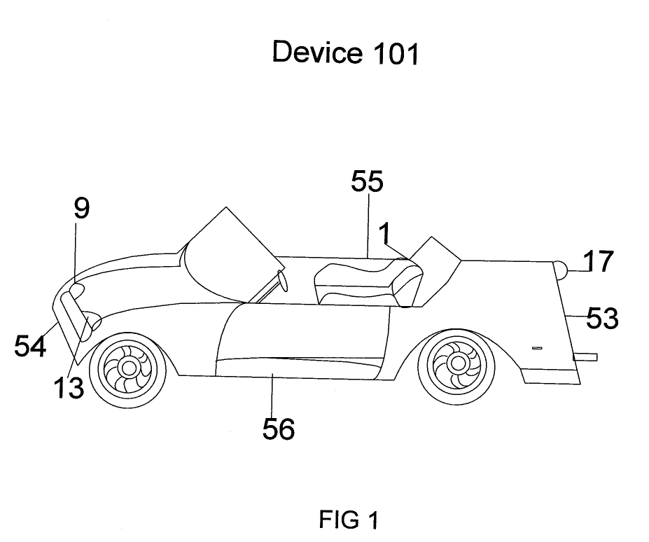

Referring to FIGS. 1 to 9, the present invention 101 is both an improved wireless, cordless optical computer input device (also known as a mouse) and a remote control toy vehicle which comprise a cover 1 and base 50.

FIG. 1 shows a left perspective view of device 101, a remote control toy vehicle housing an LED mouse. The left click button 13 and the right click button 9 are the means to actuate the cursor and LED unit 35. Although shown is the preferred embodiment, a plurality of body shells, each being shaped to resemble a different vehicle type, a chassis to which any one of the plurality of body shells is selectively and detachably coupled, and a variety of sound generating means, mounted on the chassis, for producing a plurality of sounds, each one being selectable to correspond to a selected vehicle and coupled one of the plurality of body shells. Furthermore, although shown is the preferred embodiment to fit the cupped palm of an average size adult, additional embodiments might be reduced in size to meet the needs of smaller, childlike hands.

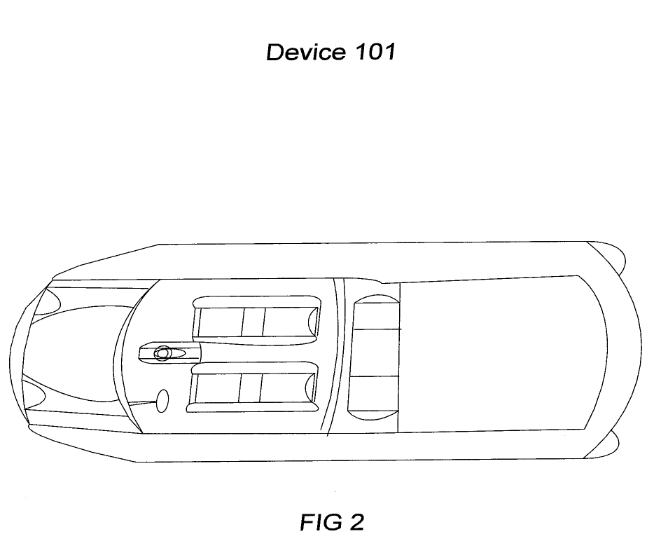

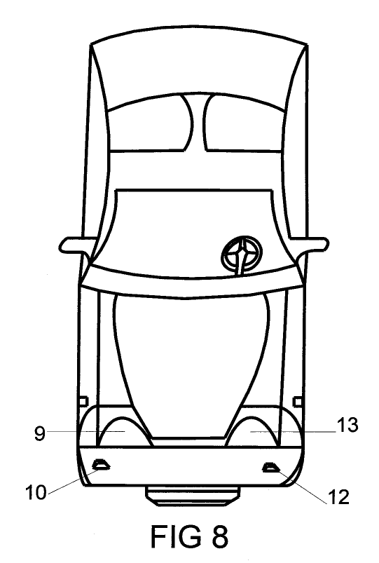

FIG. 2 shows a top perspective view of the present invention 101, a wireless optical computer input device (also called a mouse) housed in a toy remote control vehicle. The present invention 101 comprises a cover 1 and a base 50 assembled to the cover by fastening screws 24 in each of the corners. In this preferred embodiment of the present invention, the optical mouse or computer input device is wireless, with a wireless transmitter (not shown) and a wireless receiver (not shown). However, the wireless transmitter and the wireless receiver are known art and not described in detail here. In the preferred embodiment of the present invention headlights 10 and 12 (FIG. 8), and tail lights 17 and 19 illuminate when the vehicle is on and the wheels are rolled a predetermined distance. In alternative embodiments both the sound and lights might be eliminated.

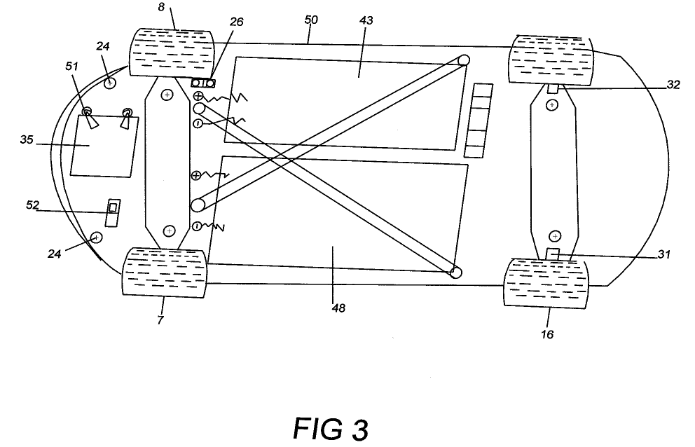

FIG. 3 shows the bottom perspective view of device 101 turned over. When the present invention 101 is used as a remote control vehicle, the retractable LED unit 35 is tucked away inside the cover 1, and secured by the retractable LED unit levers 51. The on/off switch 26 engages the remote control vehicle and is prepared to receive signal from the remote control vehicle transmitter 58 through the antenna 29 which in the preferred embodiment shown, is secured under the cover 1. Power sources for the vehicle 43 (9.6 volt) and 48 the wireless optical mouse (computer input device) (1.5 volt) provide power to device 101 and can be a conventional battery. The batteries can be rechargeable, but need not be. Other battery technologies, such as nickel, hydride, lithium ion, lithium polymer, or zinc air can also realize power. In the preferred embodiment of the present invention a sound track 52 comprising of silly remarks is employed by the user with an on/off switch.

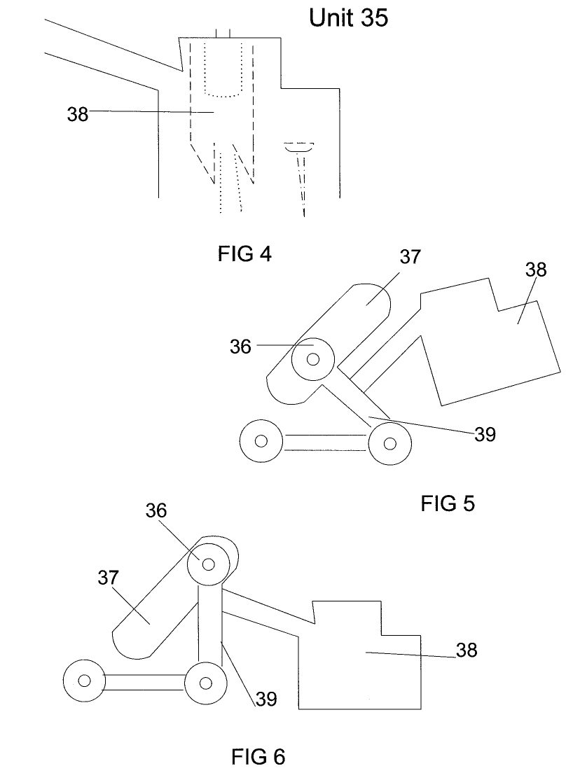

FIG. 4 illustrates an exploded view of a wireless input device that employs an optical sensor in accordance with one embodiment of the present invention. The retractable Light Emitting Diode (LED) unit 35 includes an LED 38, and optical sensor 42. In alternative embodiments, optical sensor 42 can have a photo-sensitive element. In addition, optical 42 might have no lens (e.g. reflected light is received directly by a photo-sensitive element) or more than one lens (e.g. one lens between LED 38 and the reflecting surface.) Furthermore, said retractable LED unit 35 might be constructed as a push in and release, in which said locking means comprising a lever 51 mounted on the underside of base 50 which when pushed vertically over LED unit 35, said unit is locked in the closed position. Said retractable LED unit 35 being characterized in that: the LED frame has a runner 37 secured to the mouse/vehicle housing, and has a guide finger 36 attached to said arm 39 hinged to the LED structure; and said arm is the means for causing the LED unit 35 to retract and expand. Likewise, LED 38 might have a lens integrated therein. The retractable LED unit 35 is optically sensed and translated into position data, and is communicated to the computer via the wireless connection. Light from the LED 38 reflects off the support surface as the vehicle moves, and the reflected light is focused on an optical sensor 42 via a lens. In such an embodiment, the support surface could be most any surface such as a table top, sheet of paper, wall, arm, leg, mouse pad, or binder. The point here is that the device 101 will work on many diverse surfaces and need not be limited to a special mouse pad or other dedicated surface.

FIG. 5 shows the exploded side perspective of retractable LED unit 35 in the up position (not in use)

FIG. 6 shows the exploded side perspective of retractable LED unit 35 in the down position (the LED unit is in use)

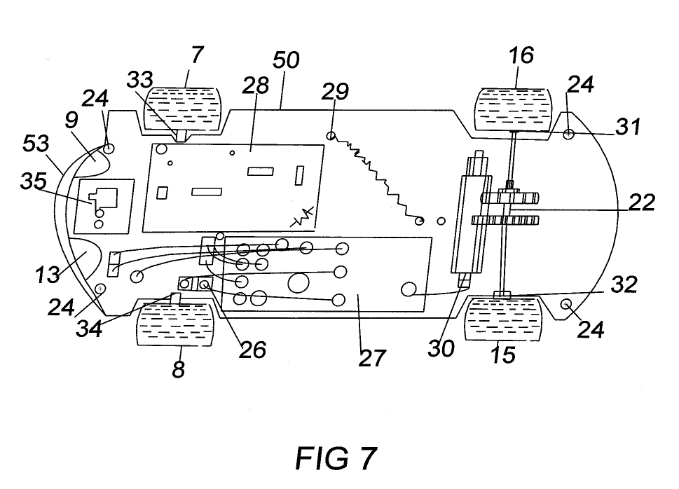

FIG. 7 is the perspective view of top side of base 50, which when assembled is directly beneath the cover 1, the printed circuit board 27 for the remote control toy vehicle, whereas printed circuit board 28 is for the computer input device (mouse.) Furthermore, this perspective view illustrates the location of the gears 22, axles 31, 32, 33, and 34, the drive motor 30, and the retractable LED unit 35. Control of the toy vehicle portion of device 101 is conventional. The vehicle includes circuitry 27 indicated in FIG. 7, preferably located in the central chassis towards the first longitudinal position 53, which and including a wireless, preferably radio frequency (RF) receiver on said circuitry board 27, preprogrammed microprocessor or microcontroller operably coupled with receiver 27, and with propulsion/steering motor control circuits. The operation of the motor 30 is controlled by the microprocessor in response to control signals received by the receiver located on said circuitry board 27 from a remote control unit 58 generating and transmitting wireless maneuver control signals. The vehicle, device 101 is propelled by controlling motor 30 to rotate the plurality of road wheels in the same direction at the same speed and is steered by controlling the motors to drive the wheels on either lateral side 55, 56 of either lateral chassis portion 53, 54. Light sources 12, 17, 10, 19 are hard wired with the battery power supply 43 to be constantly on when on-off switch 26 is set to the ON position, closing the circuitry through battery 26, according to the embodiment of the present invention.

In the present invention and preferred embodiment, a sound track located on circuit board 27 might be included and wired to power supply 43 for use by the consumer at will by using the on/off switch 52.

FIG. 8 is the front view of device 101 with the LED 35 in the operational position.

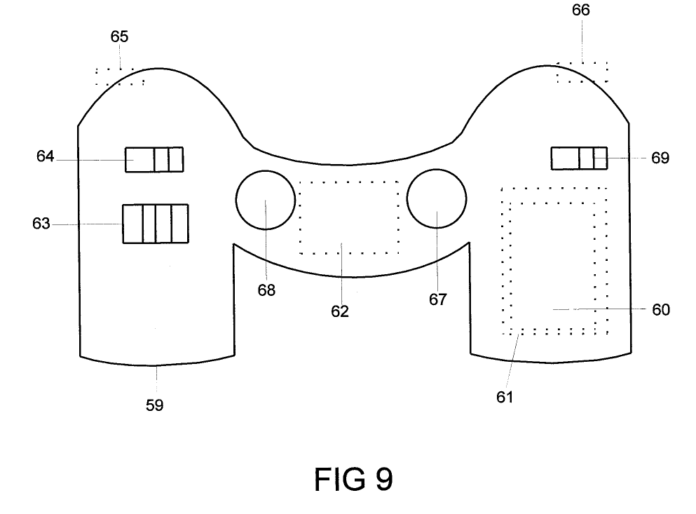

FIG. 9 transmitter or controller 58 which transmits radio signals to be received by the remote control toy vehicle 101 in a conventional manner. In one embodiment, the controller 58 includes a housing which is shaped similar to a two handled gaming device already in use for various games. The housing 59 is secured with a plurality of screws therein.

The controller 58 includes a button steering wheel knob that rotates by thumb movement for the right thumb 67 and left thumb 68, which pushing the button knob causes the toy vehicle 101 to move forward, backwards or to the left or right.

The controller 58 also includes a left/right switch 63 to actuate either one of the steering button knobs, to communicate with the steering control circuit on the circuit board 62 not shown, as well as the speed control button for either the left 65 or the right 66 which communicates with the speed control circuit on the circuit board 62 not shown.

The controller 58 comprises an on/off switch 69 on the device 58, an on/off switch 64 to actuate toy vehicle lights 10, 12, 17, and 19, underside, as well as a power supply battery pack 60 and battery cover 61 not shown. The batteries can be rechargeable, but need not be. Other battery technologies, such as nickel, hydride, lithium ion, lithium polymer, or zinc air can also realize power.

In the preferred embodiment, a floor mat or computer pad for racing a device 101 against another device 101 is optional. Inclusion of said rugs or mats will not detract from the operation of the LED mouse or remote control toy vehicle, it would only add to the fun and stress relief device 101 can provide.

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined by the appended claims.

I claim:

1. A device for computer inputting or pointing surrounded by a remotely controlled toy vehicle comprising:
a. a housing configured of some rigid material to resemble a reduced-scale vehicle which can fit in the cupped palm of an average sized adult;
b. at least one on-board power supply positioned underneath said housing to power said remote controlled toy vehicle;
c. at least one freely rotate-able wheel supporting said housing and configured to rotate the plurality of wheels when the remotely controlled toy vehicle moves along an external surface;
d. a driving motor selectively reversible between first and second directions of rotation;
e. a drive mechanism drivingly connecting the driving motor to at least one of the plurality of road wheels, such that operation of the driving motor in either of the first and second directions of rotation causes rotation of at least one road wheel to propel the toy vehicle in a forward vehicle direction;
f. a controller circuit configured to selectively supply power from the power supply to at least one motor in response to commands from a transmitter remote from the vehicle to the toy vehicle;
g. a three part chassis having opposing a first longitudinal end and a second, opposing longitudinal end and including a central chassis portion having opposing first and second lateral sides;
h. a computer input device affixed and situated between the exterior toy vehicle surface and the chassis and battery packs; providing displacement information to a computer operating system;

2. The device for computer inputting or pointing surrounded by a remote controlled toy vehicle in claim 1 comprises:
a. a light source from a group such as light emitting diode for generating a light beam to illuminate an image area;
b. an illumination lens for directing the light beam from the light source to the imaged area on a surface;
c. the imaged area of the surface reflecting light;
d. the received reflected light for use in providing the displacement information from the imaged area to the computer;
e. a transparent resin for housing the light source comprising of a slit area to allow the converged light to be passed therethrough;

3. A remote controlled toy vehicle with computer input pointing device having the motor and movement of claim 1.

4. A remote controlled toy vehicle with computer input pointing device having the light-receiving unit of claim 2.

5. An individual power supply source for the computer input device in claim 2.

6. A transmitter, remotely controlled with its own power supply, to cause the vehicle in claim 1 to move.

7. A plurality of same sized, moveable support wheels for the remote control toy vehicle in claim 1.
